(19) United States
(12) Patent Application Publication
(10) Pub. No.: US 2003/0178872 A1
(43) Pub. Date: Sep. 25, 2003

(54) Vehicle, and vehicle body element

(76) Inventor: Thomas Lich, Schwaikheim (DE)

Correspondence Address: STRIKER, STRIKER & STENBY, 103 East Neck Road, Huntington, NY, 11743, US

(21) Appl. No.: 10/390,092

(22) Filed: Mar. 17, 2003

(30) Foreign Application Priority Data
Mar. 25, 2002 (DE) 102 23 367.5

(51) Int. Cl. B60J 7/00

(52) U.S. Cl. 296/187.09

(57) ABSTRACT

A vehicle has a coating which is at least partially composed of a metal foam, and a vehicle body element can be at least partially composed of a metal foam.

### BACKGROUND OF THE INVENTION

The present invention relates to a vehicle body element or to a vehicle.

Vehicles and vehicle body elements of vehicles are well known. It is believed that they can be further improved.

### SUMMARY OF THE INVENTION

Accordingly, it is an object of the present invention to provide a vehicle body element or a vehicle, which are further improvements of the existing vehicle body elements and vehicles, correspondingly.

In keeping with these objects and with others which will become apparent hereinafter, one feature of the present invention resides, briefly stated, in a vehicle body element which at least partially is composed of a metal foam.

In accordance with another feature of the present invention a vehicle is proposed, in which an outer coating of the vehicle has at least partially a metal foam.

When the body element and the vehicle are designed in accordance with the present invention, then during an impact the energy of the impact can be taken and absorbed.

Metal foams have a cellular structure, similarly to bone or wood. Various melting metallurgical manufacturing processes are known for producing metal foams. The use of such an absorption material eliminates the use of sensors and control devices for pedestrian impacts. Thereby, a substantially simpler and cost-favorable measures are provided for pedestrian protection.

When in the present application a vehicle body element is mentioned, it is to be understood that it can be a part of a chassis of the motor vehicle which is arranged on the outer surface of the vehicle.

In accordance with the present invention it is especially advantageous when the metal foam has aluminum. In particular, foam aluminum has a porous structure which is especially advantageous for the use in the vehicle technology.

It is further of advantageous that the metal foam is arranged so that it can optimally absorb the energy of an impact, in particular a pedestrian impact, and therefore leads to an optimal protection of the pedestrians.

Moreover, it is advantageous when in accordance with the present invention the vehicle body element is a motor hood and/or bumper, since these body elements are hit in the event of an accident with a pedestrian.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a vehicle in accordance with the present invention with a metal foam; and

FIG. 2 is a view showing a metal foam which is a part of a motor hood, after an impact.

### DESCRIPTION OF THE PREFERRED EMBODIMENTS

In the field of a pedestrian protection there are many ideas for sensing systems and actuating systems. Mainly, bumper sensors are utilized for pedestrian impact detection. For this purpose, force sensors or deformation sensors are used, which extend over the whole width of the vehicle in the bumper. For example, piezofoils, strain gauge strips, light conducting sensors, sensors of a composite and the like are utilized as such sensors.

The deformation sensors are partially also light conductors or simple switches. For detecting the type of the impact several sensors are used with one another. For the protection itself substantially airbag systems are integrated in the motor spaces or the motor hoods are lifted, in order to counteract the impact of the person correspondingly.

Many sensors or actuators must be developed and adapted to each vehicle. This is very cost intensive and time intensive. Later on, repair costs can be also expected. It is therefore an object of the present invention, to guarantee a sufficient pedestrian impact protection without additional sensor systems or further control devices or components.

In accordance with the present invention a motor vehicle is proposed, whose outer coating at least partially has a metal foam. In particular the motor hood and/or the bumper are formed partially of metal foam. Preferably aluminum is used for this purpose. The metal foam is arranged so that the metal foam absorbs the energy of an impact.

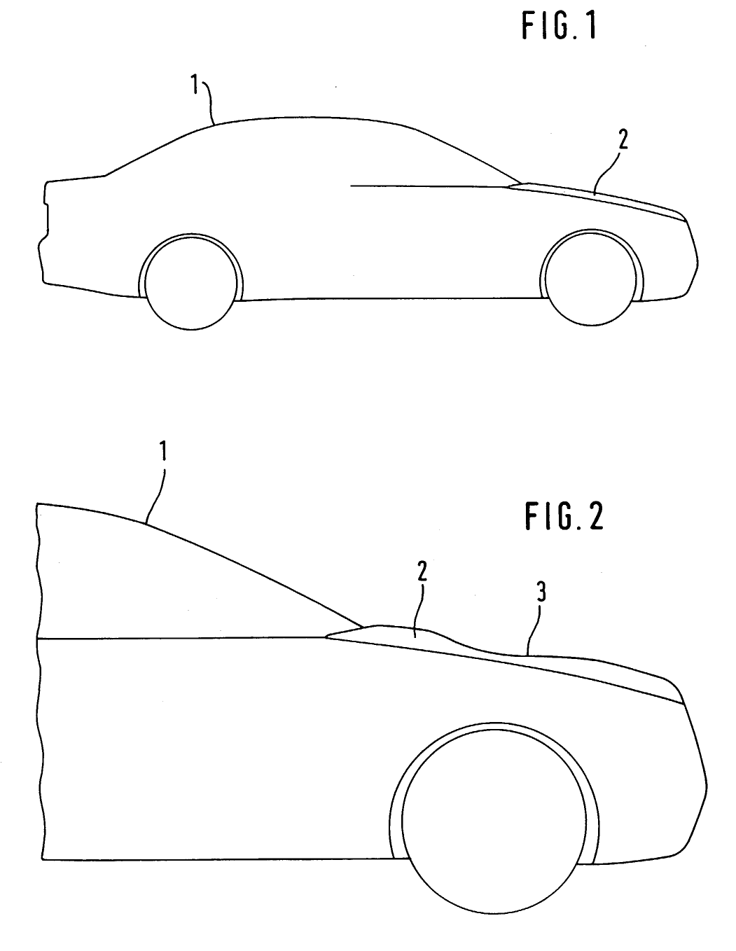

FIG. 1 shows a motor vehicle 1 with an outer coating which has at least partially a metal foam 2. Here it is the motor hood which is formed at least partially of metal foam. Aluminum is proposed as the material. However, also other metal foams of other metals are possible as well.

FIG. 2 shows the metal foam 2 which forms the motor hood of the vehicle 1. The metal foam 2 is shown here after an impact with a pedestrian. A knocked-out portion 3 can be seen, which is caused by the impact. The elastic metal foam 2 can absorb the impact energy by compression of its volume. Thereby an optimal pedestrian protection is possible with minimal expenses.

The metal foam must be formed so that the metal foam under normal loading, such as application of a load to it, is not compressed. However, it is compressed when an impact force caused by an impact is applied. Such a limit can be for example caused by a force of 500 newton.

The metal foam can be provided over a whole area or also only over a partial surface. A carrier of metal can be arranged between the metal foam areas. It should be mentioned that during an impact the deformation of the metal foam is carried out first elastically, and then after a certain impact energy a plastic deformation occurs. Such a plastic deformation must occur only at very high impact energies. The elastic deformation which serves for restoring the metal foam to its original shape must occur in the majority of passenger impact situations to absorb the energy. In other words, the knocked-out portion 3 in FIG. 2 in the case of a normal passenger impact is only for a short time, and thereby after the impact and removal of the impact object it comes back to its original shape.

It will be understood that each of the elements described above, or two or more together, may also find a useful application in other types of constructions differing from the types described above.

While the invention has been illustrated and described as embodied in vehicle, and body element, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A vehicle body element, comprising a part which is composed of metal foam.

2. A vehicle body element as defined in claim 1, wherein the metal foam has aluminum.

3. A vehicle body element as defined in claim 1, wherein the metal foam is arranged so that it absorbs energy of an impact.

4. A vehicle body element as defined in claim 2, wherein the metal foam arranged so that it absorbs energy of an impact.

5. A vehicle body element as defined in claim 1, wherein said body element is a motor hood.

6. A vehicle body element as defined in claim 1, wherein said body element is a bumper.

7. A vehicle, comprising an outer coating applied on the vehicle, said outer coating at least partially having a metal foam.
